(19) United States
(12) Patent Application Publication
(10) Pub. No.: US 2002/0197186 A1
(43) Pub. Date: Dec. 26, 2002

(54) Air treatment devices

(76) Inventor: Joseph C. Murray, Columbus, OH (US)

Correspondence Address: Sean M. Casey Co., L.P.A., Attention: Sean M. Casey, P.O. Box 710, New Albany, OH, 43054-0710, US

(21) Appl. No.: 09/885,522

(22) Filed: Jun. 20, 2001

(51) Int. Cl. B01F 3/04

(52) U.S. Cl. 422/124; 422/123

(57) ABSTRACT

An air treatment device that is placed in fluid communication with an environment to be treated or an air stream moving about an air handling apparatus, that includes, among other elements, a replenishable and or resealable porous container, which is or which contains a treatment substance. The container is preferably positioned proximate to the air stream by an optional retainer that supports the container by way of one or more attachment devices. The retainer may be formed from a telescopically mated pair of side walls. The attachment device(s) are preferably configured to adjustably and releasably connect the treatment device to the air handling apparatus and equipment. In variations of the preferred configurations, the attachment devices can include magnets, adhesives, hook and loop type fasteners, reconfigurable clips, and posts and ties, and any desired combination thereof. The treatment substances can be any of a wide variety of desired materials, which include, for example, odoriferous, pesticidal, fungicidal, and bacteriocidal substances in forms ranging from scented liquids, solids, and beads to potpourri and odorous powders, granules, and fibrous sheets and materials impregnated or treated with such substances. In modifications of the preferred arrangements, the porous container may be formed from a flexible polymeric sheet material as a pouch, which may also further include a tongue and groove type resealable closure about one side.

### TECHNICAL FIELD

This invention relates to single use, replaceable, and replenishable, and refillable air treatment devices and similar devices that are compatible for use in a wide variety of industrial, commercial, healthcare, residential, automotive, and similar applications.

### BACKGROUND OF THE INVENTION

In the air handling industry, many methods and devices have been employed in the past to treat air prior to introduction to a work space, living area, and other area having an occupant that would benefit from receiving treated air. For example, attempts have been made to dispense a scent into a moving air stream as described in U.S. Pat. No. 5,141,707 to Brite. The device suggested by Brite is limited to an odorant container having a hinged cover that is incorporated into a prefabricated air register. The porous odorant container is configured to receive and contain a fragrance producing substance that passes into the moving airstream.

Another type of air freshener has been suggested in U.S. Pat. No. 4,067,692 by Farris. The Farris odor control device is restricted to a device that must be mounted to the interior of an air passageway of an air conditioning and heating system. This variant is further limited to a device that incorporates thermostatically controlled shutters and a rotatable airflow regulator plate that governs the flow of air through the odor control device.

Other types of air freshening devices having suggested application for vents and ventilation registers are described in U.S. Des. Pat. Nos. D411,002 to Farmer and D288,713 to Darneal. The Farmer device is limited to a device that appears to have very limited application for use with certain types of vent constructions that are not immediately apparent from a review of the various figures. The Darneal device has a very different construction and also appears to have application for a particular type of vent construction that is not readily understood with reference to the various diagrams.

What has been needed but heretofor unavailable in the prior art devices and methods, is an air treatment device that is compatible for use with a wide variety of air movement and handling devices and equipment and that does not require a specific type of vent or air handling equipment construction. Instead, it is preferably that such an air treatment device be compatible for use with the most widely used air handling equipment presently in use in industrial, commercial, health-care, automotive, and residential applications. The most preferable device would be compatible for use in ventilation, heating, and air conditioning systems used in factories, offices, hospitals, homes, cars, trucks, and other application specific environments. Additionally, the preferred device should be configured for single use applications as well as replenishable and refillable applications.

In all such proposed applications, there has long been a need to provide an easy to use, economical, and widely compatible air treatment device that does not require any specific construction or configuration of the air handling and treatment equipment. Moreover, what has been missing in the previous devices is an apparatus that can be employed with a minimum of waste, in either single use or replenishable applications, and the most possible flexibility in use, but which does not impose undue or unnecessary cost or complexity upon the user. Moreover, the preferred apparatus should be easily adapted to perform well with any of a variety of air treatment substances and in all of the attendant environments contemplated herein.

The present invention meets these and other needs without adding any complexity, inefficiencies, or significant costs to implementation in existing air handling equipment and devices, such as and including those suggested herein. The various embodiments of the present invention disclosed are readily adapted for ease of manufacture, low fabrication costs, and immediate compatibility with both the most widely available air handling equipment used the previously described environments, as well as air treatment substances most desired by users and that are presently in use and which may subsequently become available.

### SUMMARY OF INVENTION

In its most general aspect, the present invention injects a variety of new capabilities into the field and overcomes many of the shortcomings of the prior art in any of a number of generally effective configurations. In one of the preferable configurations, the device according to the present invention includes an air treatment device that is positioned to be in fluid communication with an air stream that is moved through and about an air handling apparatus, such as an air movement, heating, cooling, humidification, or filtration system, or some combination thereof. Such systems may include, for example, systems as straightforward in construction as a floor or window fan, home, automotive, ship, and aircraft heating and cooling systems, and systems as complex as an industrial air filtration, conditioning, and humidification control system, such as those used in silicon wafer fabrication facilities, and other types of advanced micro-particle control systems. Although the phrase “air-stream” is used throughout the accompanying description, the phrase, in addition to its plain and ordinary meaning is also used to refer to the surrounding and perhaps ambient or unmoving air mass. For purposes of the instant invention, even the seemingly unmoving or still surrounding and otherwise ambient air mass would still be useful in the context of the preferred configurations, modification, and variations of the device according to the present invention. This is because such a “still” air mass, is still subject to the Newtonian motion of constituent dust and air molecules whereby the dust and molecules would kinetically communicate with and be in what is commonly referred to as “fluid communication” with the device according to the present invention.

The inventive device is compatible for use with, and in certain embodiments may incorporate, a treatment substance, such as, for purposes of illustration but not limitation, odoriferous, pesticidal, fungicidal, and bacteriocidal gaseous, liquid, solid state, and flowable substances in forms ranging from scented liquids, solids, and beads to potpourri and odorous, vapor emitting, outgassing, and sublimating powders, granules, materials, and fibrous sheets and materials that are impregnated or treated with such treatment substances. The treatment substance may be in a stand-alone form or be contained within, on, or about a substrate carrier material, which may, in turn be in any of the states or forms contemplated and described herein.

Among other features and elements, the device also preferably further includes a replenishable and sealable porous container. The container is generally and preferably adapted to receive the treatment substance and to be positioned in the moving air stream of the air handling apparatus. Although the word “container” is used herein to describe this element of the invention, the preferred configurations may not necessarily be restricted to a container in the classic and customary definition of the word. More generally, the word container is used to refer to not only containers in the most customary and plain meaning definition of the word, but also to refer to any medium or substrate that may facilitate the communication of the treatment substance to the surrounding and perhaps moving air stream.

The porous container of the air treatment device may also be in the form of or may incorporate a medium that is adapted to receive a fluid state form of the treatment substance. For example, the container may be in form of a fibrous sheet type material, or of similar construction, that is adapted to absorb a fluid substance and to retain the fluid while allowing the fluid, or ingredients in the fluid, to vaporize and evaporate over time and into the moving air stream. Alternatively, the medium may be positioned within the container and operate in a similar manner.

In other alternative configurations of the preferred device, the porous container may be formed from a flexible polymeric sheet material as a pouch, which may have a construction similar to the food storage “Zip-Loc®”-type bag available in most grocery and department stores in the United States. In such alternative modifications to the preferred form of the instant invention, the porous container may also further incorporate a resealable tongue and groove type side closure device that is formed in a side of the pouch, which is the most common type pouch type container closure device that is used in the United States for purposes of storing a variety of foods and dry goods, and other types of substances and materials that are equally suitable for storage in a plastic bag. More preferably, the porous container is formed from such a polymeric material to have a porosity that promotes the desired degree or volume of communication of the treatment substance into the surrounding environment or into the adjacent moving air stream of the air handling device.

In optional modifications and variations to the preferred configuration, the device farther may include a retainer that is formed to support the treatment substance container. Also, the device preferably incorporates one or more attachment devices, which are configured to releasably and adjustably attach either the container or the retainer, or both, to the air handling apparatus. The retainer may also further be formed or constructed to have a reclosable pair of telescopically mated side walls, which are sized whereby one of the side walls is telescopically received to be releasably captured by and or within the cooperating other side wall. Alternatively, the opposing side walls may be mirror images of one another or identically formed and adapted to releasably and or permanently capture each other in a mating relationship, and to thereby cooperate to support the treatment substance container.

In further modifications to the preferably configuration of the device according to the instant invention, the air treatment device may optionally further incorporate attachment devices which, for purposes of illustration, may be in the form of magnets, including materials having magnetic properties, releasable and permanent adhesives, hook and loop type fasteners, such as Velcro®, releasable clamps, reconfigurable clips, such as resilient or deformable plastic clips, and posts and ties, such as posts that protrude or project outwardly from the retainer or the container, or both, and such as bendable and connectable and or tieable fibrous, elastic, plastic, and wire ties that can fasten to the posts, and combinations and variations thereof.

These variations, modifications, and alterations of the various preferred embodiments may be used either alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, wherein like reference numerals across the several drawings, figures, and views refer to identical, corresponding, or equivalent elements, features, and parts:

FIG. 1 is an elevated perspective view, in reduced scale, of an air treatment device according to the present invention and configured as a container for storing and communicating a treatment substance;

FIG. 2 is a rotated section view, in enlarged scale, taken along section line 2-2 of FIG. 1;

FIGS. 3 through 6 are elevated perspective views of the device of FIG. 1, with variations and modifications to certain features;

FIG. 7 is an elevated perspective view, in reduced scale, of the device of FIG. 5 shown in operation in various configurations;

FIGS. 8 and 9 are elevated perspective views, in reduced scale, of variations of the device of FIGS. 1 and 6, respectively, shown in operation in various configurations;

FIG. 10 is an elevated perspective view, in reduced scale, of the device of FIGS. 4 and 5 shown in operation in various arrangements;

FIG. 11 is an elevated perspective view, in reduced scale, of the device of FIG. 1 shown in operation;

FIG. 12 is an elevated perspective view, in reduced scale, of the device of FIG. 5 shown in operation;

FIG. 13 is an elevated perspective view, in reduced scale, of the device of FIGS. 3 and 4 shown in operation;

FIG. 14 is an elevated perspective view, in reduced scale, of the device of FIGS. 1, 3, and 4 shown in operation; and

FIG. 15 is a rotated side view, in enlarged scale, taken along section line 15-15 of FIG. 14.

### DESCRIPTION OF THE PREFERRED EMBODIMENT

The air treatment device according to the present invention enables a significant advance in the state of the art of such devices and has wide application in the use of various types of treatment substances that are used in consumer, residential, commercial, industrial, healthcare, and other specialized settings and environments. The preferred configurations and described alternatives, modifications, and variations of the air treatment device of the instant invention accomplish this by new and novel constructions and arrangements of elements that are is configured in unique and novel ways and which demonstrate previously unavailable capabilities.

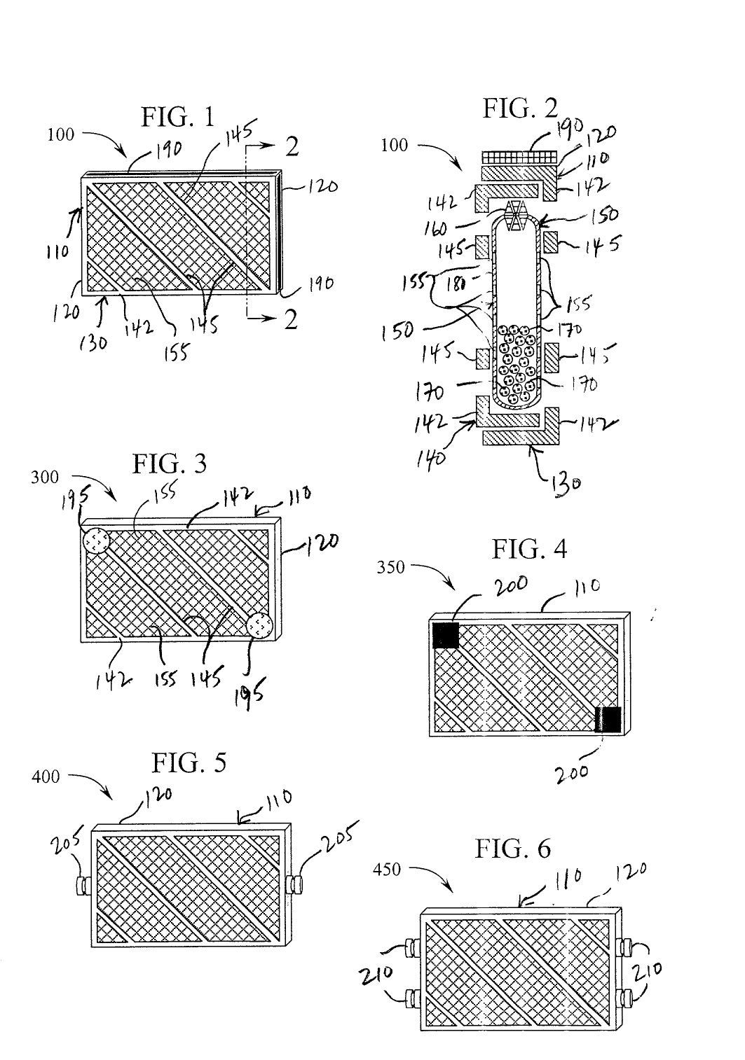

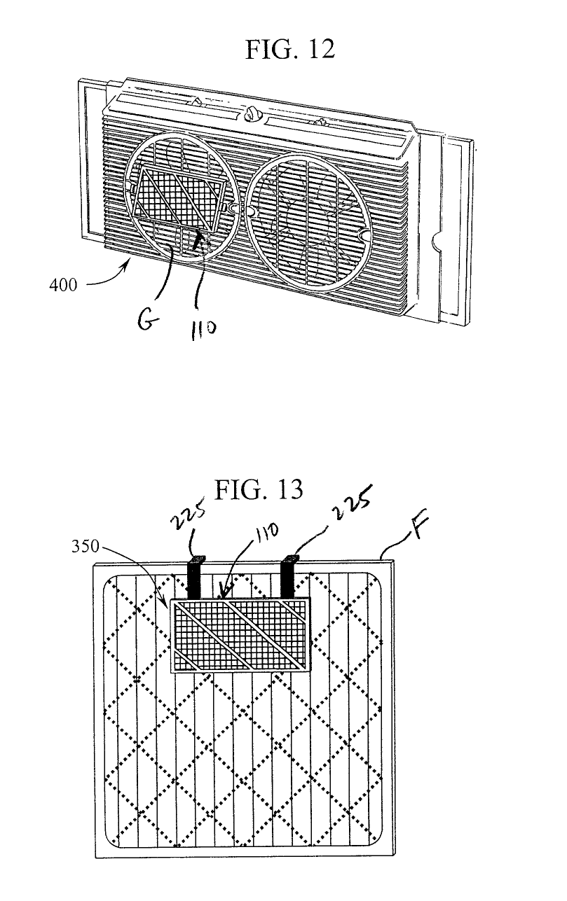

With reference now to the accompanying figures and specifically to FIGS. 1 through 15, air treatment devices 100, 300, 350, 400, and 450 are shown, which are configured for receiving, storing, and for communicating one or more treatment substances to the surrounding environment, including, for purposes of illustration but not limitation, an air handling apparatus such as those described herein. As represented in the various figures, the apparatuses 100, 300, 350, 400, and 450 are not shown to scale but are shown in one of many possible and equally desirable representative relative dimensional proportions, as will be apparent to those with skill in the art. For example, although devices 100, 300, 350, 400, and 450 are shown to have a generally cuboid configuration, any of a wide variety of equally suitable 3-dimensional envelopes is available and would be compatible for purposes of the present invention. As a further example, other relative dimensional cuboid shapes may be more suited to a particular application. Similarly, other shapes that may have application include spherical, ovoid, pyramidal, conical, and similar constructions.

The air treatment apparatuses 100, 300, 350, 400, and 450 preferably incorporate or are configured to be a replenishable and sealable porous container 110. The container 110 is, in turn, configured to be or to receive a treatment substance and to be positioned in the moving air stream of the air handling apparatus. The porous container 110 also preferably includes a retainer 120 that is formed to be and or to support the treatment substance container 110. The retainer 120 may also further be formed or constructed to have a reclosable pair of telescopically mated side walls 130, 140, that are sized whereby one of the side walls 140 is telescopically received to be releasably captured by and or within the cooperating other side wall 130, which may optionally “snap” onto the received wall 140. The telescopic mating arrangement is only one possible configuration. Alternatively, the opposing side walls 130, 140 may be mirror image or identically formed and adapted so as to releasably or permanently capture one another in a mating relationship (not shown), to thereby cooperate to support the treatment substance container. Any of a number of fastening methods may be employed, including for example, overcenter latches, slot and dimple or tongue arrangements, and the like (not shown).

In variations of the preceding configurations, the retainer 120 may have open recesses formed between upper, lower, side members 142, and support ribs 145 that are sized to capture other elements within the retainer 120.

In other alternative configurations of the preferred devices 100, 300, 350, 400, and 450, the porous container 110 may further include or be formed from a flexible polymeric sheet material as a pouch 150, which may have a construction similar to the food storage “Zip-Loc®”-type bag available in most grocery and department stores in the United States. In such alternative modifications, the porous container 110, and more specifically, the pouch 150 may also further incorporate a resealable tongue and groove type side closure device 160 that is formed in a side of the pouch 150. The container 110 can have its porosity varied by adjusting the recesses that are formed between the members 142 and ribs 145, as well as by recesses or pores 155 that may be formed in the polymeric material of the pouch 150 or other similar container that may be employed. With specific reference to FIGS. 1 and 2, such pores 155 are schematic represented by the cross-hatching shown in FIG. 1 and the cut-away recesses shown in FIG. 2.

With continued reference to FIGS. 1 through 15, and specifically also to FIG. 2, as previously described, the devices 100, 300, 350, 400, and 450 are compatible for use with, and in certain embodiments may incorporate, one stand-alone or a combination of one or more odoriferous, pesticidal, fungicidal, and bacteriocidal treatment substance(s) that may be in a gaseous, liquid, or solid state, and combinations thereof, and that may solid but flowable or that may be solid or liquid but which emit a gaseous treatment substance. Such treatment substances can be in the form of solids such as beads or potpourri, designated schematically by reference numeral 170, or other materials, such as that depicted generally and schematically by reference numeral 180, which may be, include, or incorporate the desired treatment substance or combination of substances. As stated, the treatment substance may be in a stand-alone form or be contained within, on, or about a substrate carrier material, such as in the form of the material 180 that is illustrated in FIG. 2.

As can be understood with continued reference to FIG. 2, the medium or material 180 may be in form of a fibrous sheet type material, such as that schematically depicted by reference numeral 180 or of a similar construction, which is adapted to absorb a fluid, vapor, or gaseous treatment substance, retaining it while allowing the vaporization and or evaporation during exposure to the surrounding environment or moving air-stream. Such material 180 may be configured to be contained with retainer 120 without the need for the additional configuration that includes the pouch 150. Alternatively, both retainer 120 and pouch 150 may be used in combination with material 180 and the other forms of treatment substances depicted in FIG. 2 by reference numeral 170.

In the most preferred arrangements and configurations, the air treatment device 110 preferably incorporates one or more attachment devices, such as those depicted generally in the various figures, and specifically by reference numerals 190, 195, 200, 205, 210, 220, and 225. Such attachment devices are most preferably configured to releasably and adjustably attach the air treatment devices 100, 300, 350, 400, and 450, and more specifically, the container 110 and or the retainer 120, or both, to a structure in the applicable environment and or to a structure on or within the air handling apparatus.

With continued reference to the various figures and more specifically to FIGS. 1 through 6, those with skill in the art can understand the operation and configuration of the various attachment devices contemplated by the instant invention. In FIG. 1, the air treatment device 100 is configured with a magnetic, adhesive, or hook and loop type fastener 190 that is carried along upper, side, and lower support members 142 for attaching the device 100 to the surrounding structure or air handling equipment. In a further illustrative example, and with reference also to FIGS. 8 and 11, the device 100 may be affixed to portions of a register deflector D such as that illustrated in FIG. 8 or to the interior wall(s) of a duct or register R as shown in FIG. 11.

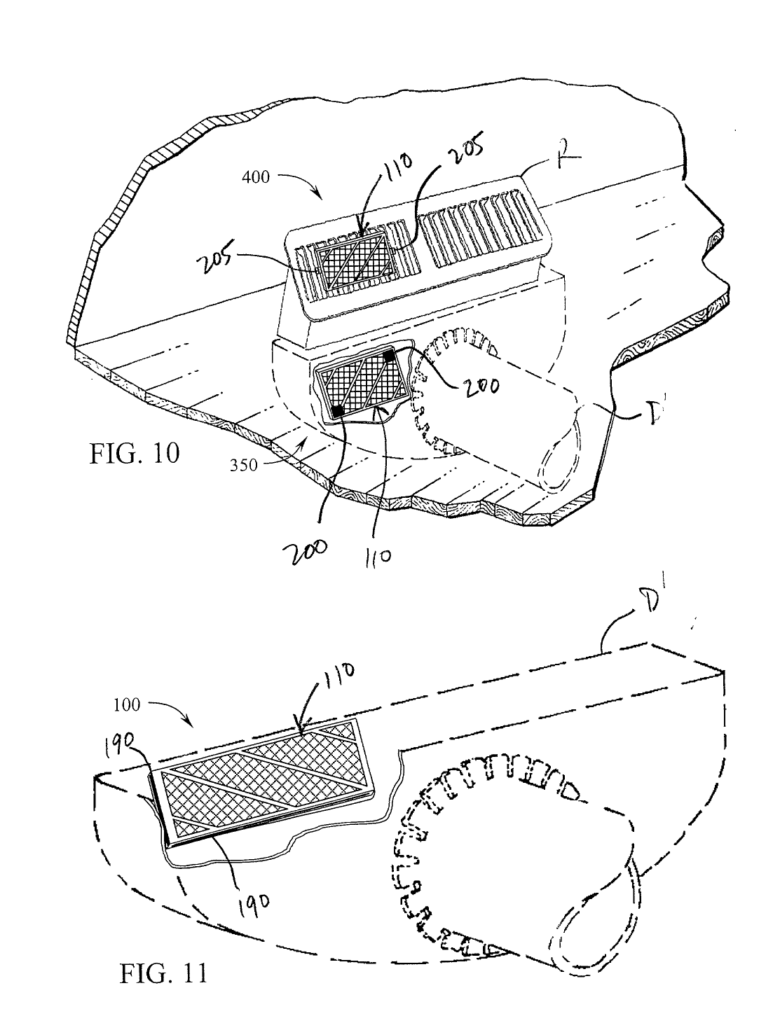

In another example, and with reference also now to FIG. 3, the device 300 may be configured with hook and loop type or adhesive fasteners 195, for attachment to air handling related apparatuses such as a typically filter, like that designated generally by reference letter F of FIGS. 13, 14, and 15. With reference also to FIG. 4, device 350 may incorporate attachment devices 200, which may be similar in construction to that described in connection with FIG. 3, but which may also be constructed of a magnet or magnetic material capable of attaching the devices 300, 350 to ducts, registers, and other structures, as can be further understood with reference also to the various figures, including for purposes of illustration FIGS. 10 and 13.

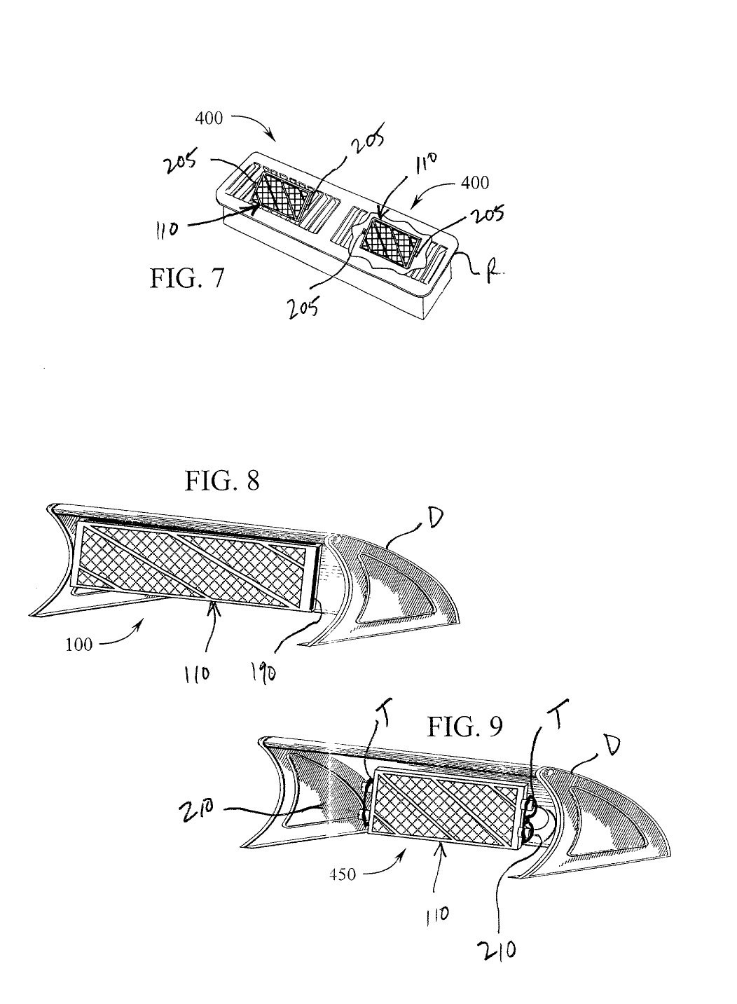

With continued reference to each of the figures and also specifically to FIGS. 5 and 6, the air treatment devices 400 and 450 may incorporate attachment devices such as posts 205, 210, which can be used in cooperation with fibrous, plastic, and wire ties, and elastic strips and bands, denoted generally in FIG. 9 by reference letter T, to attach the devices 400, 450 to any of the preceding structures and air handling equipment. With reference also now specifically to FIGS. 7, 9, and 10, such connection devices and methods may be incorporated and employed to attach the devices 400, 450 to, about, on top of, beneath, adjacent to air vents including ceiling, wall, free-standing, and floor mounted vents, registers R, grilles G, screens, and in air handling transmission pathways including vent and register deflectors D, ducts D′, and on structures and devices such as filters F, and in, on, about, and near similar structures, whereby the treatment substance(s) will be communicated to the surrounding environment, and into the moving air-stream, if any.

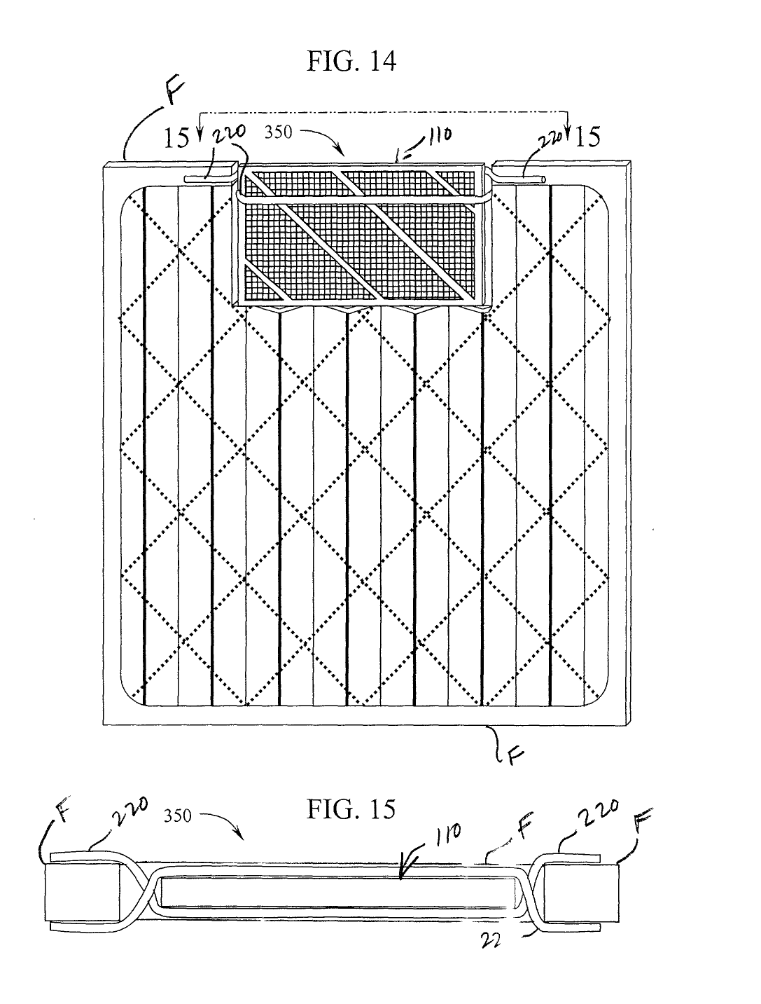

With reference also specifically to FIGS. 14 and 15, it can be understood by those with skill in the art that any of the preceding air treatment devices 100, 300, 350, 400, and 450 are adapted for use with a deformable, bendable, and or resilient clip, such as that formed by one or more clips 220. Such clips 220 may be integrally formed into the devices 100, 300, 350, 400, and 450, or may be included therewith for installation in the desired configuration. In such configurations, any prospective user may create a cut-away portion of a standard air handling filter F that is sized to accommodate any of the preferred air treatment devices 100, 300, 350, 400, and 450. Next, a clip, such as clip 220 may be employed to releasably and adjustably retain the devices 100, 300, 350, 400, and 450 in the desired configuration. Although a generally bendable clip 220 is depicted in the various figures. A more rigid clip is also contemplated (not shown) that may be integrally formed with or be otherwise connected to the air treatment devices 100, 300, 350, 400, and 450.

Although not depicted in the figures, those with skill in the art can further comprehend that such bendable or deformable clips 220 may be further formed of a spring steel or piano wire and to have coiled springs, and to further have small end hooks, which can be used as spring clips to attach the devices 100, 300, 350, 400, and 450 to filters, such as filter F of FIGS. 13 through 15, as well as to any of the previously described structures, and those structures and equipment contemplated herein. In yet another variation, releasable clamps, including jack screw type and spring clamps, may also be used in place of or in combination with any of the preceding elements, arrangements, and configurations. Such clamps are typically of the construction known to those with skill in the art, respectively, either as wood clamps, which are used to hold articles together during curing of an adhesive, or as “clothes pins,” wherein the latter have been used to, for example, retain clothing and other items on a hung line that is employed to air out or dry damp articles. Such clamps are also used in construction and carpentry applications to hold together articles for purposes of allowing adhesives to cure. Additionally, similarly configured spring clamps are used to releasably attach battery recharging cables to the battery post. Such spring type clamps can be modified for purposes of the instant to similarly hold the air treatment devices 100, 300, 350, 400, and 450 according to the present invention to any of the previously described structures. Additionally, those familiar with the art will may also understand that the attachment devices 190, 195, 200, 205, 210, and 220 may also be replaced with or used in combination with hangers 225 that can be formed from strips or wires of various materials and to enable the air treatment devices to be hung about the support structure and air handling equipment. For example, the devices 100, 300, 350, 400, and 450 may be hung about a typical filter apparatus, such as the filter F depicted in FIG. 13.

Numerous alterations, modifications, and variations of the preferred embodiments, configurations, modifications, variations, and alternatives disclosed herein will be apparent to those skilled in the art and they are all contemplated to be within the spirit and scope of the instant invention. For example, although specific embodiments have been described in detail, those with skill in the art can understand that the preceding embodiments and variations can be further modified to incorporate various types of substitute and/or additional treatment substances, construction materials, relative arrangement of elements, and dimensional configurations for compatibility with the wide variety of environments and air handling systems known to and available in the industry. Accordingly, even though only few variations of the present invention are described herein, it is to be understood that the practice of such additional modifications and variations and the equivalents thereof, are within the spirit and scope of the invention as defined in the following claims.

I claim:

1. An air treatment device in fluid communication with an air stream moving about an air handling apparatus, comprising:
a treatment substance;
a replenishable and sealable porous container adapted to receive the treatment substance and to be positioned in the air stream;
a retainer formed to support the container; and
a plurality of attachment devices formed about the retainer and adapted to adjustably and releasably engage the air handling apparatus.

2. The air treatment device according to claim 1, wherein the attachment devices are selected from the group including magnets, adhesives, hook and loop type fasteners, reconfigurable clips, and posts and ties, and combinations thereof.

3. The air treatment device according to claim 1, wherein the treatment substance is selected from the group including flowable and solid substances, which are further selected from the group including odoriferous, pesticidal, fungicidal, and bacteriocidal substances, and combinations thereof.

4. The air treatment device according to claim 1, wherein the porous container further includes a medium adapted to receive a fluid treatment substance.

5. The air treatment device according to claim 1, wherein the porous container is formed from a flexible polymeric sheet material as a pouch.

6. The air treatment device according to claim 5, wherein the porous container further incorporates a resealable tongue and groove type side closure device that is formed in a side of the pouch.

7. The air treatment device according to claim 1, wherein the retainer is formed from a reclosable pair of telescopically mated side walls.

8. An air treatment device for communicating a treatment substance into an air stream moving about an air handling apparatus, comprising:
a replenishable and sealable porous container adapted to receive the treatment substance and to be positioned in fluid communication with the air stream; and
a plurality of attachment devices adapted to adjustably and releasably engage the air handling apparatus.

9. The air treatment device according to claim 8, wherein the attachment devices are selected from the group including magnets, adhesives, hook and loop type fasteners, reconfigurable clips, and posts and ties, and combinations thereof.

10. The air treatment device according to claim 8, wherein the treatment substance is selected from the group including flowable and solid substances, which are further selected from the group including odoriferous, pesticidal, fungicidal, and bacteriocidal substances, and combinations thereof.

11. The air treatment device according to claim 8, wherein the porous container further includes a medium adapted to receive a fluid treatment substance.

12. The air treatment device according to claim 8, wherein the porous container is formed from a flexible polymeric sheet material as a pouch.

13. The air treatment device according to claim 12, wherein the porous container further incorporates a resealable tongue and groove type side closure device that is formed in a side of the pouch.

14. The air treatment device according to claim 8, further comprising:
a retainer that is formed from a reclosable pair of telescopically mated side walls.

15. An air treatment device for communicating a treatment substance into an air stream moving about an air handling apparatus, comprising:
a replenishable and porous container adapted to receive the treatment substance and to be positioned in fluid communication with the air stream; and
an adjustable attachment device adapted to releasably engage the air handling apparatus.

16. The air treatment device according to claim 15, wherein the attachment device is selected from the group including a magnet, an adhesive, a hook and loop type fastener, a reconfigurable clip, and a post and a tie, and combinations thereof.

17. The air treatment device according to claim 15, wherein the treatment substance is selected from the group including flowable and solid substances, which are further selected from the group including odoriferous, pesticidal, fungicidal, and bacteriocidal substances, and combinations thereof.

18. The air treatment device according to claim 15, wherein the porous container is selected from the group including a medium adapted to receive a fluid treatment substance, a polymeric flexible sheet material formed as a pouch, a retainer adapted to carry an outgassing solid treatment substance, a retainer adapted to carry a sublimating solid treatment substance, and combinations and variations thereof.

19. The air treatment device according to claim 15, wherein the porous container is formed from a flexible polymeric sheet material as a pouch.

20. The air treatment device according to claim 19, wherein the porous container further incorporates a resealable tongue and groove type side closure device that is formed in a side of the pouch.

21. The air treatment device according to claim 15, further comprising:
a retainer that is formed from a reclosable pair of telescopically mated side walls.
